(19) United States
(12) Patent Application Publication
(10) Pub. No.: US 2003/0098519 A1
(43) Pub. Date: May 29, 2003

(54) Method and device for automatically controlling hydraulic pressure in hydraulic cylinder for hot runners of pressure regulating injection molding machines

(75) Inventor: Young-Hee Yu, Seoul (KR)

Correspondence Address: McDERMOTT, WILL & EMERY, 600 13th Street, N.W., Washington, DC, 20005-3096, US

(73) Assignee: Yudo Co. Ltd.

(21) Appl. No.: 10/167,390

(22) Filed: Jun. 13, 2002

(30) Foreign Application Priority Data
Nov. 28, 2001 (KR) 2001-0074490

(51) Int. Cl. B29C 45/77

(52) U.S. Cl. 264/40.1; 425/135; 425/549

(57) ABSTRACT

A method and device for automatically controlling hydraulic pressure in a hydraulic cylinder for hot runners of pressure regulating injection molding machines is disclosed. This device is provided with a pressure regulating unit, having both a pressure regulating spring and a pressure regulating head, at each of two hydraulic ports formed at the upper and lower portions of the cylinder's sidewall, and makes one of the two units open an associated hydraulic port when a pressure, exceeding a reference level predetermined by both the spring force of the pressure regulating spring and the cross-sectional area of the pressure regulating head, acts on the piston of the cylinder. A predetermined quantity of pressurized oil is discharged from the cylinder through the open port and thereby maintains desired constant pressure acting on the piston in the cylinder. This device has a simple construction, and reduces the number of required solenoid valves of the cylinder from four to two, thus being easily produced at low production cost. The device also automatically regulates the hydraulic pressure inside the cylinder, and forces the actuation oil to continuously flow from the cylinder, thus preventing carbonization of the oil in the cylinder.

### BACKGROUND OF THE INVENTION

1. Field of the Invention

The present invention relates, in general, to the structure of hydraulic cylinders for hot runners of pressure regulating plastic injection molding machines and, more particularly, to a method and device for automatically controlling hydraulic pressure in such a cylinder by installing a pressure regulating unit at each of two hydraulic ports formed at the upper and lower portions of the cylinder's sidewall, and by automatically draining a predetermined quantity of pressurized oil from the cylinder through either port when the pressure inside the cylinder is excessively increased, thus preventing a piston from being overloaded and preventing carbonization of oil in the cylinder.

2. Description of the Prior Art

As well known to those skilled in the art, a hydraulic cylinder for hot runners of pressure regulating plastic injection molding machines has been produced after appropriately designing the cylinder in accordance with desired capacity of a valve pin.

During an injection molding process, hydraulic pressure in the cylinder may be changed, and the pressure applied to the piston of the cylinder may be also changed. When the pressure in the cylinder excessively increases, the injection molds may be damaged at the gates brought into contact with the nozzle of the cylinder. In such a case, the hot runner may fail to perform its desired operation.

Such a hydraulic cylinder for injection molding machines comes into close contact with a heated hot runner, and so actuating oil inside the cylinder may be heated and carbonized.

In a detailed description; the hydraulic cylinder for hot runners of injection molding machines is a small diameter cylinder, and so the quantity of actuation oil contained in the cylinder bore is only several ten milliliters.

Since the actuation oil is contained in the heated cylinder, the cylinder may excessively heat the oil and thereby deteriorate the oil's chemical and physical characteristics, in addition to carbonizing the oil.

During a plastic injection molding process, the actuation oil is repeatedly fed into and drained from the hydraulic cylinder while flowing through a long hydraulic line. It is necessary to use four solenoid valves for controlling the flow of actuation oil relative to one hydraulic cylinder.

In order to prevent the actuation oil from being undesirably discharged from the cylinder through an oil inlet port during an oil draining step, the oil inlet port and the oil outlet port of the cylinder must be provided with solenoid valves, respectively, for forcing the actuation oil to flow in one direction.

The conventional hydraulic cylinder for hot runners thus complicates the construction of a hydraulic circuit. Another problem of the conventional cylinder resides in that it is almost impossible to install the solenoid valves when the cylinder is used with small-sized molds.

### SUMMARY OF THE INVENTION

Accordingly, the present invention has been made keeping in mind the above problems occurring in the prior art, and an object of the present invention is to provide a device for automatically controlling hydraulic pressure in a hydraulic cylinder for hot runners of pressure regulating injection molding machines, which is provided with a pressure regulating unit, having both a pressure regulating spring and a pressure regulating head, at each of two hydraulic ports formed at the upper and lower portions of the cylinder's sidewall, and in which one pressure regulating unit automatically opens an associated hydraulic port when a pressure, exceeding a reference level predetermined by both the spring force of the pressure regulating spring and the cross-sectional area of the pressure regulating head, acts on the piston of the cylinder, thus discharging a predetermined quantity of pressurized oil from the cylinder through the open port and thereby maintaining desired constant pressure acting on the piston in the cylinder.

Another object of the present invention is to provide a method and device for automatically controlling hydraulic pressure in a hydraulic cylinder for hot runners of pressure regulating injection molding machines, which continuously receives new oil due to the automatic draining of oil by the operation of the pressure regulating units, thus preventing the oil from being carbonized in the cylinder by heat of the hot runner.

In order to accomplish the above objects, the present invention provides a method of automatically controlling hydraulic pressure in a hydraulic cylinder for hot runners of pressure regulating injection molding machines, comprising the steps of: feeding pressurized oil to the hydraulic cylinder to move a piston in the cylinder in a direction by hydraulic pressure of the oil acting on the piston; moving a pressure regulating head in the same direction by the hydraulic pressure of the oil while compressing a pressure regulating spring when the hydraulic pressure acting on the piston is excessively increased, thus opening a hydraulic port connected to the pressure regulating head and draining the oil from the cylinder through the open hydraulic port; and returning the pressure regulating head to an original position thereof by restoring force of the pressure regulating spring when the hydraulic pressure acting on the piston is reduced and does not overcome the restoring force of the spring due to the draining of the oil from the cylinder through the open hydraulic port.

The present invention also provides a device for automatically controlling hydraulic pressure in a hydraulic cylinder for hot runners of pressure regulating injection molding machines, comprising: a cylinder body movably receiving a piston and having an oil outlet port and an oil inlet port at the upper and lower ends of a sidewall thereof in a way such that the oil outlet port communicates with an upper chamber above the piston and the oil inlet port communicates with a lower chamber under the piston, the oil inlet and outlet ports feeding and draining pressurized oil into and from the cylinder body; two seating holes axially formed in the sidewall of the cylinder body at diametrically opposite positions so as to allow the upper and lower chambers of the cylinder body to communicate with an oil line outside the cylinder body through the seating holes; and a pressure regulating unit set in each of the two seating holes of the cylinder body and selectively opening the seating hole so as to discharge a predetermined quantity of pressurized oil from the cylinder body to the oil line for maintaining a desired constant hydraulic pressure in the cylinder body, the pressure regulating unit consisting of a pressure regulating head movably seated in a nozzle of the seating hole, a pressure regulating spring set in the seating hole to normally bias the pressure regulating head in a direction for closing the nozzle, and a plug set in the seating hole at a position behind the pressure regulating spring so as to hold the pressure regulating head and spring in the seating hole.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view showing the construction of a device for automatically controlling hydraulic pressure in a hydraulic cylinder for hot runners of plastic injection molding machines in accordance with the preferred embodiment of the present invention; and

FIG. 2 is a sectional view of a cylinder body of the hydraulic cylinder according to this invention.

### DETAILED DESCRIPTION OF THE INVENTION

Reference now should be made to the drawings, in which the same reference numerals are used throughout the different drawings to designate the same or similar components.

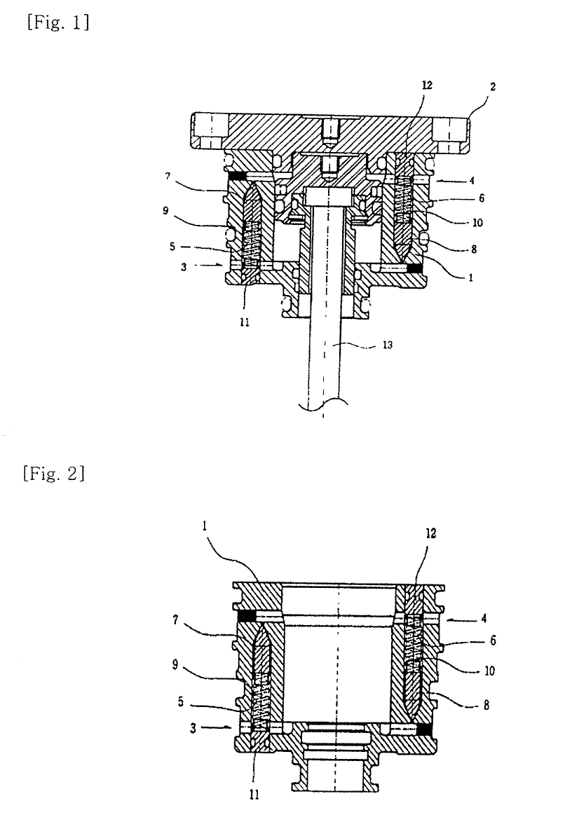

FIG. 1 is a sectional view showing the construction of a device for automatically controlling hydraulic pressure in a hydraulic cylinder for hot runners of plastic injection molding machines in accordance with the preferred embodiment of the present invention. FIG. 2 is a sectional view of a cylinder body of the hydraulic cylinder according to this invention.

As shown in the drawings, the device for automatically controlling hydraulic pressure in the hydraulic cylinder according to this invention comprises a cylinder body 1 covered with a cylinder head la to define a cylinder bore, with a piston 2 movably received in the cylinder bore to define a variable upper chamber and a variable lower chamber in the cylinder body 1. An oil inlet port 3 and an oil outlet port 4 are formed at the lower and upper ends of the sidewall of the cylinder body 1 to communicate with the lower chamber and the upper chamber of the cylinder body 1, respectively. The two oil ports 3 and 4 feed or drain pressurized oil into or from the cylinder body 1. Two seating holes 5 and 6 are axially formed in the sidewall of the cylinder body 1 at diametrically opposite positions such that the lower chamber of the cylinder body 1 may communicate with the oil outlet port 4 through the hole 6 and the upper chamber of the cylinder body 1 may communicate with the oil inlet port 3 through the hole 5. Two pressure regulating units are set in the two seating holes 5 and 6 of the cylinder body 1 so as to selectively open the seating holes 5 and 6 and discharge a predetermined quantity of pressurized oil from the cylinder body 1 for maintaining desired constant hydraulic pressure in the cylinder body 1. Each of the pressure regulating units consists of a pressure regulating head 7 or 8 movably seated in a nozzle of each seating hole 5 or 6, a pressure regulating spring 9 or 10 set in the seating hole 5 or 6 to normally bias the pressure regulating head 7 or 8 in a direction for closing the nozzle, and a plug 11 or 12 set in the seating hole 5 or 6 at a position behind the pressure regulating spring 9 or 10 so as to hold the pressure regulating head 7 or 8 and the pressure regulating spring 9 or 10 in the seating hole 5 or 6. In the drawings, the reference numeral 13 denotes a valve pin connected to the piston 2.

The hydraulic pressure control device of this invention is operated as follows.

When pressurized actuation oil is fed through the oil inlet port 3 into the lower chamber under the piston 2 inside the cylinder body 1, the piston 2 is moved upward in the cylinder body 1 by the hydraulic pressure of the oil.

In such a case, the pressure regulating head 8 associated with the oil outlet port 4 is biased downward by the spring force of its pressure regulating spring 10, thus closing the nozzle of the seating hole 6.

When the piston 2 is fully moved upward to reach its upper dead point and the pressurized oil is further fed into the lower chamber of the cylinder body 1, the hydraulic pressure inside the lower chamber is excessively increased to overcome the spring force of the spring 10 seated in the hole 6 associated with the oil outlet port 4. The pressure regulating head 8 is moved upward while compressing the spring 10 by the hydraulic pressure, thus opening the nozzle of the hole 6.

When the nozzle of the hole 6 is opened as described above, the pressurized oil is discharged from the lower chamber to the oil outlet port 4, and so the hydraulic pressure inside the lower chamber is reduced. When the hydraulic pressure inside the lower chamber is reduced such that the pressure does not overcome the restoring force of the spring 10, the pressure regulating head 8 is elastically moved downward by the restoring force of the spring 10 to close the nozzle of the hole 6.

When the oil flowing direction of the hydraulic cylinder is reversed to move the piston 2 downward in the cylinder body 1, the pressure regulating unit set in the hole 5 is operated to automatically control the hydraulic pressure in the upper chamber above the piston 2 in the cylinder body 1.

That is, when pressurized actuation oil is fed through the oil outlet port 4 into the upper chamber of the cylinder body 1, the piston 2 is moved downward in the cylinder body 1 by the hydraulic pressure of the oil. When the piston 2 is fully moved downward to reach its lower dead point and the pressurized oil is further fed into the upper chamber, the hydraulic pressure inside the upper chamber is excessively increased to overcome the spring force of the spring 9 seated in the hole 5 associated with the oil inlet port 3. The pressure regulating head 7 is moved downward while compressing the spring 9 by the hydraulic pressure, thus opening the nozzle of the hole 5. Therefore, the pressurized oil is discharged from the upper chamber to the oil inlet port 3, and so the hydraulic pressure inside the upper chamber is reduced. When the hydraulic pressure inside the upper chamber is reduced such that the pressure does not overcome the restoring force of the spring 9, the pressure regulating head 7 is elastically moved upward by the restoring force of the spring 9 to close the nozzle of the hole 5. The hydraulic pressure control device of this invention thus automatically controls the hydraulic pressure in the cylinder body 1 such that excessively high pressure does not act on the piston 2. Therefore, the device protects the cylinder body 1 and piston 2 from such excessively high pressure, and allows the valve pin 13 to be operated under desired pressure, thus protecting the gate of hot runners.

In addition, since the hydraulic pressure control device of this invention has two pressure regulating units in the sidewall of the cylinder body at positions corresponding to the oil inlet and outlet ports, it is possible to effectively control the operation of the hydraulic cylinder such that the actuation oil flows in a desired direction using two solenoid valves for lifting and lowering the piston, different from a conventional hydraulic cylinder having four solenoid valves.

As described above, the present invention provides a method and device for automatically controlling hydraulic pressure in a hydraulic cylinder for hot runners of pressure regulating injection molding machines. The device of this invention is provided with a pressure regulating unit, having both a pressure regulating spring and a pressure regulating head, at each of two hydraulic ports formed at the upper and lower portions of the cylinder's sidewall, and makes one pressure regulating unit open an associated hydraulic port when a pressure, exceeding a reference level predetermined by both the spring force of the pressure regulating spring and the cross-sectional area of the pressure regulating head, acts on the piston of the cylinder. A predetermined quantity of pressurized oil is discharged from the cylinder through the open port and thereby maintains desired constant pressure acting on the piston in the cylinder. The device of this invention has a simple construction, and reduces the number of required solenoid valves of the cylinder from four to two, thus being easily produced at low production cost. The device also automatically regulates the hydraulic pressure inside the cylinder, and forces the actuation oil to continuously flow from the cylinder, thus preventing carbonization of the oil in the cylinder.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of automatically controlling hydraulic pressure in a hydraulic cylinder for hot runners of pressure regulating injection molding machines, comprising the steps of:
feeding pressurized oil to the hydraulic cylinder to move a piston in said cylinder in a direction by hydraulic pressure of the oil acting on the piston;
moving a pressure regulating head in the same direction by the hydraulic pressure of the oil while compressing a pressure regulating spring when the hydraulic pressure acting on the piston is excessively increased, thus opening a hydraulic port connected to the pressure regulating head and draining the oil from the cylinder through the open hydraulic port; and
returning the pressure regulating head to an original position thereof by restoring force of said pressure regulating spring when the hydraulic pressure acting on the piston is reduced and does not overcome the restoring force of the spring due to the draining of the oil from the cylinder through the open hydraulic port.

2. A device for automatically controlling hydraulic pressure in a hydraulic cylinder for hot runners of pressure regulating injection molding machines, comprising:
a cylinder body movably receiving a piston and having an oil outlet port and an oil inlet port at upper and lower ends of a sidewall thereof in a way such that the oil outlet port communicates with an upper chamber above the piston and the oil inlet port communicates with a lower chamber under the piston, said oil inlet and outlet ports feeding and draining pressurized oil into and from the cylinder body;
two seating holes axially formed in the sidewall of said cylinder body at diametrically opposite positions so as to allow the upper and lower chambers of the cylinder body to communicate with an oil line outside the cylinder body through the seating holes; and
a pressure regulating unit set in each of the two seating holes of the cylinder body and selectively opening the seating hole so as to discharge a predetermined quantity of pressurized oil from the cylinder body to the oil line for maintaining a desired constant hydraulic pressure in the cylinder body, said pressure regulating unit consisting of a pressure regulating head movably seated in a nozzle of the seating hole, a pressure regulating spring set in the seating hole to normally bias the pressure regulating head in a direction for closing the nozzle, and a plug set in the seating hole at a position behind the pressure regulating spring so as to hold the pressure regulating head and spring in the seating hole.

3. The device according to claim 2, wherein said two seating holes communicate with the oil inlet port and the oil outlet port, respectively, and the pressure regulating unit set in each of the two seating holes drains the pressurized oil from an associated chamber of the cylinder body to an associated one of the oil inlet port and the oil outlet port.
